(19) United States
(12) Patent Application Publication
(10) Pub. No.: US 2003/0208497 A1
(43) Pub. Date: Nov. 6, 2003

(54) Customer relationship management system

(75) Inventors: Bradley J. Witter, Indianapolis, IN (US); Kyle P. Zeronik, Carmel, IN (US); Bryan L. Goossen, Indianapolis, IN (US)

Correspondence Address: Intellectual Property Group, Bose McKinney & Evans LLP, 2700 First Indiana Plaza, 135 North Pennsylvania Street, Indianapolis, IN, 46204, US

(73) Assignee: National Notification Center, LLC

(21) Appl. No.: 10/136,238

(22) Filed: May 1, 2002

(51) Int. Cl. G06F 17/00

(52) U.S. Cl. 707/100

(57) ABSTRACT

A program for processing contacts from consumers includes a plurality of software routines activated in a sequence corresponding to common steps performed when processing a contact, including an identification routine for generating an identification screen to enable an operator to input information identifying a consumer contacting the operator to communicate an issue, a look-up routine for searching a database containing a plurality of issue histories to identify an issue history associated with the consumer, and a subject routine for generating a subject screen to enable the operator to input information relating to the issue. A product routine is also included that generates an issue summary containing the issue information for storage in the database as part of the issue history associated with the consumer. The program also includes an activity routine for generating an activity screen to enable the operator to input information describing an activity to address the issue. The issue may be stored in the database in association with the operator or another party responsible for completion of the issue summary.

### FIELD OF THE INVENTION

The present invention generally relates to call processing systems and more specifically to a program for use on computer systems to assist an operator in processing a contact from a consumer about an issue relating to a product wherein the software provides a logical sequence of screens for obtaining information relating to the customer and the issue and generating an activity to respond to the issue, organizes issue information and activity information in a database structure linked to a consumer identifier, and provides the ability to assign responsibility for the issue and track the issue through its completion.

### BACKGROUND OF THE INVENTION

It is desirable to provide contact processing centers for receiving contacts (typically telephone calls) from consumers of products or services. Systems and methods for processing these calls are known. Generally, operators at such centers field questions from consumers regarding products, provide additional information relating to the products, or receive comments or complaints relating to the products. The information generated as a result of a call (i.e., information identifying the consumer, the product, the issue relating to the product, and the tasks or activities (if any) to be performed to address the issue) is typically inputted into a computer system by the operator during the call with the consumer. The information is stored in a database in the computer system for future reference.

Conventional contact processing systems are deficient for a variety of reasons. For example, conventional contact processing systems are unnecessarily complex and not intuitive. The software interface of such systems typically includes a form screen that requires the operator to enter information generated from the contact in a complicated format with no meaningful relationship to the common sequence of steps (or call flow) involved in processing a typical consumer contact. Accordingly, conventional systems are difficult to learn and awkward to use.

A fundamental deficiency arises from the manner in which some conventional systems store the information generated during a call. Generally, each consumer contact is processed (and stored) in isolation, without reference or linking to previous contacts from the same consumer. Although the stored information may be searched to locate, for example, previous contacts from a consumer, in high volume applications, the large number of contacts essentially prohibits searching for a consumer's contact history while the consumer is on the telephone with the operator. Without the ability to quickly obtain the consumer's contact history, the operator must process each call as if it were the first call from the consumer, leading to redundant data entry, frequent mistakes, longer telephone calls, and consumer and operator frustration.

Also, known contact processing systems are not adapted to facilitate post-contact work flow or follow-up activities. Since many contacts generate activities to be completed to address an issue raised during the contact, it is desirable to permit operators to assign responsibility for completion of such activities by forwarding an electronic message describing the issue to a party the operator believes is best suited to complete the activities or is otherwise the appropriate party to have responsibility for the issue. It is further desirable to permit operators to assign responsibility for issues to a group of parties, thereby enabling the parties in the group to determine which party will be responsible for completing the associated activity. Also desirable is a system that tracks issues through completion and permits involvement of other parties, regardless of their location. Conventional systems fail to provide these features.

### SUMMARY OF THE INVENTION

The present invention, on the other hand, provides a contact processing system and related software that stores contact information generated during processing a contact in a database structure linked to a consumer identifier, that assists the operator in processing the contact by generating screens in an intuitive call flow sequence based on the order of common steps involved in processing a contact, and that permits the operator and other parties to direct and track responsibility for issues (and the associated activities) resulting from processing the contact. Related software is described in U.S. patent application Ser. No. 09/668,306 filed Sep. 25, 2000 and entitled “Call Processing System with IVR,” which is hereby expressly incorporated herein by reference. In one embodiment, the present invention provides a program for use on a computer system to assist an operator in processing a contact, including an identification routine for generating an identification screen to enable the operator to input information identifying the consumer, a product routine, automatically evoked upon activation of a new issue button on the identification screen, for generating a product screen to enable the operator to input information identifying the product about which the consumer is calling, and a subject screen, automatically evoked upon activation of a continue button on the product screen, for generating a subject screen to enable the operator to input information describing the issue the consumer wishes to address.

The present invention further provides a program for processing contacts from consumers including an identification routine for generating an identification screen to enable the operator to identify the consumer, a look-up routine for searching a database containing issue histories to obtain an issue history associated with the consumer for displaying to the operator, and a subject routine for generating a subject screen to enable the operator to input information relating to the issue the consumer wishes to address. The program further generates an issue summary containing the issue information for storage in the database as part of the consumer's issue history.

The present invention also provides a method for processing calls from consumers including the steps of receiving a call, obtaining information identifying the consumer, using the consumer identifying information to retrieve a consumer history (including previously generated issue summaries) associated with the consumer, obtaining information relating to the issue about which the consumer is calling, generating an issue summary based on the issue information, adding the issue summary to the consumer history, and storing the consumer history.

The present invention still further provides a method for organizing a database containing information describing calls from consumers, including the steps of receiving a first call from a consumer, storing a consumer identifier in the database, linking in the database information describing the first call with the consumer identifier, receiving a second call from the consumer, and linking in the database information describing the second call with the consumer identifier.

After a contact is processed and an activity is defined to address an issue raised by the consumer during the contact, the operator may assign the issue (and associated activity) to any of a plurality of parties (or groups of parties) who can access the system via a network to review the issue and take appropriate action.

These and other features of the present invention will become more apparent, and the invention better understood upon a review of the following description and the accompanying drawings.

### BRIEF DESCRIPTION OF THE DRAWINGS

FIG. 1 is a conceptual block diagram of components and users of a system according to the present invention.

FIG. 2 is a conceptual block diagram of portions of a database containing information arranged based on an association of the information with a consumer identifier.

FIGS. 3A-C are views of screens generated by a consumer identification routine of the present invention.

FIGS. 4A-D are views of screens generated by a product routine of the present invention.

FIGS. 5A-B are views of screens generated by a subject routine of the present invention.

FIGS. 6-6A are views of screens generated by an activity routine of the present invention.

FIGS. 7A-D are views of screens generated by a letter routine of the present invention.

FIGS. 8A-B are views of screens generated by an enclosure routine of the present invention.

FIG. 9 is a view of a screen for modifying a letter created using the screens of FIGS. 7A-D.

FIG. 10 is a view of a screen generated by a survey routine of the present invention.

FIG. 11 is a view of a screen generated by a completion routine of the present invention.

FIGS. 12A-C are views of screens for viewing previously generated issue summaries and adding additional activities to the previously generated issue summaries.

FIGS. 13A-C are views of screens generated by an order routine of the present invention.

FIG. 14 is a view of a screen associated with an enclosure inventory management feature of the present invention.

FIG. 15 is a view of a screen generated by a report routine of the present invention.

### DETAILED DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention.

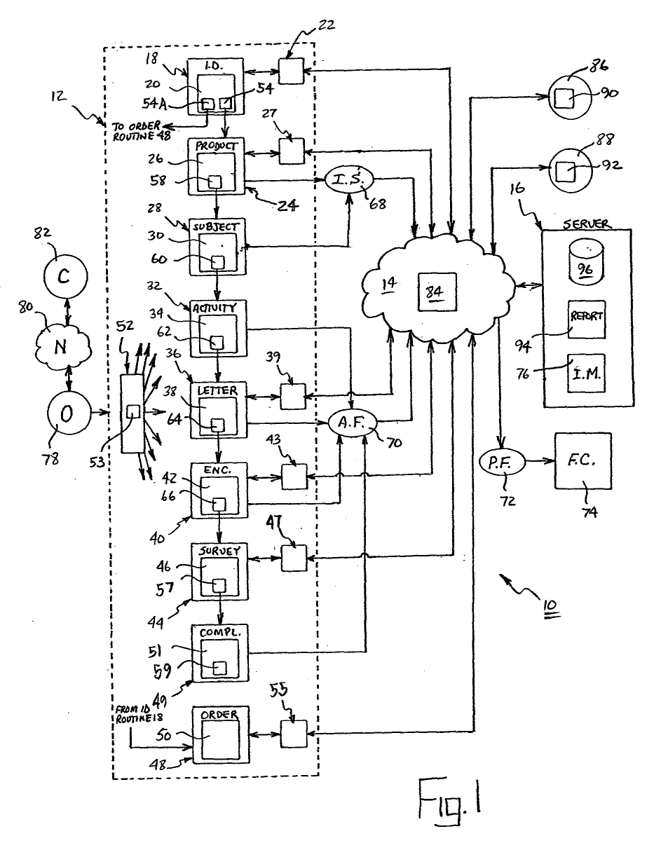

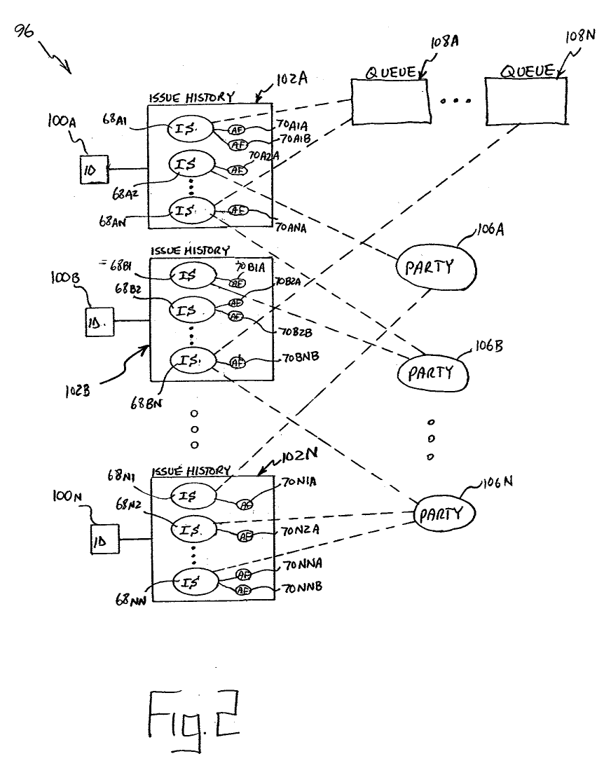

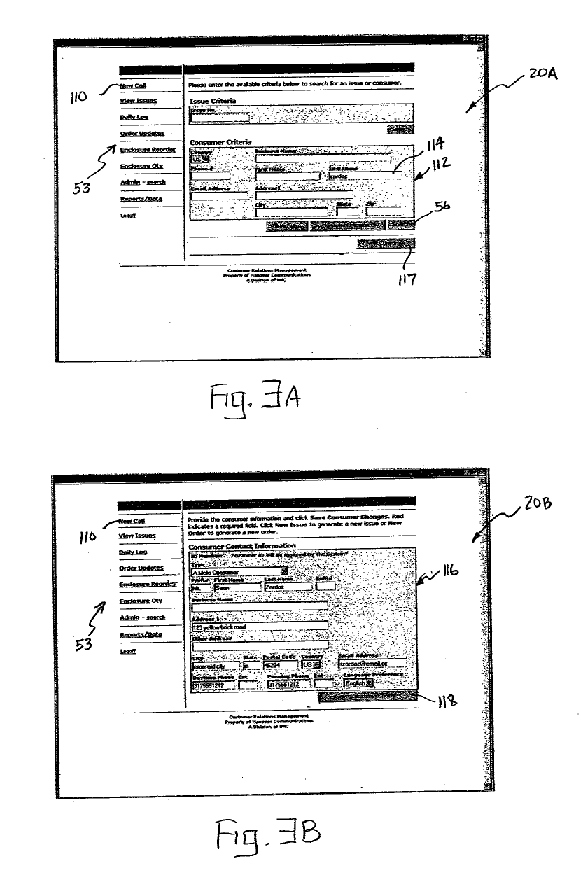

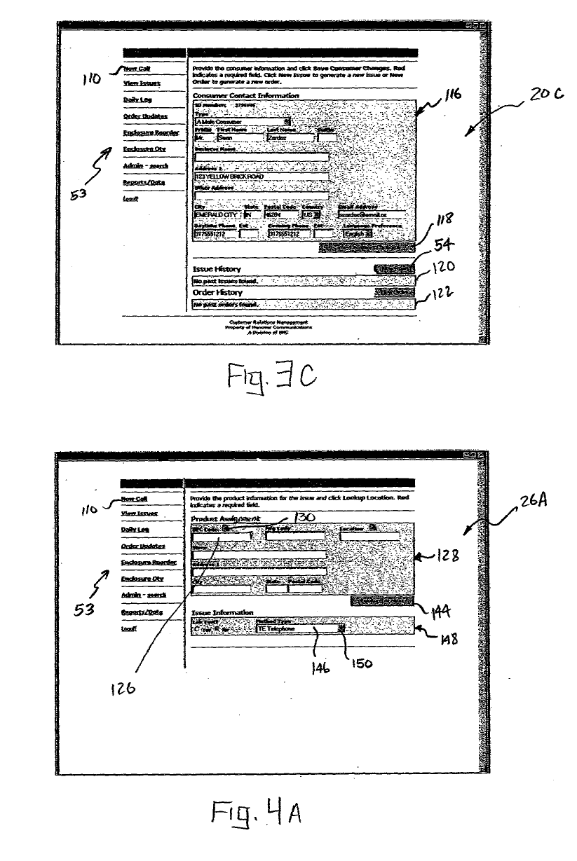

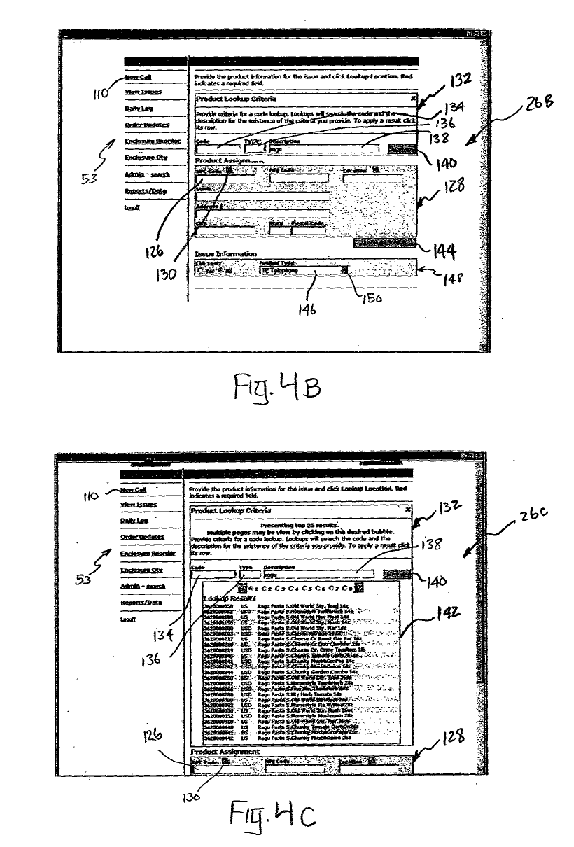

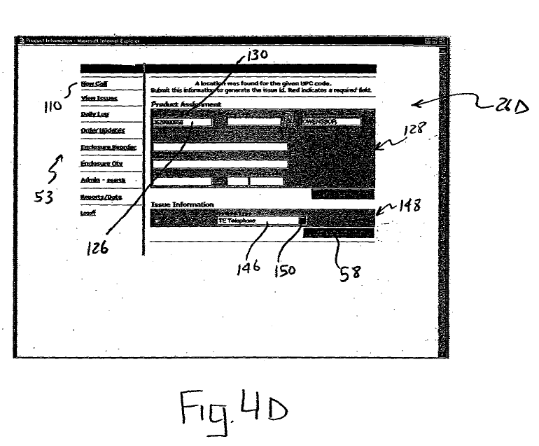

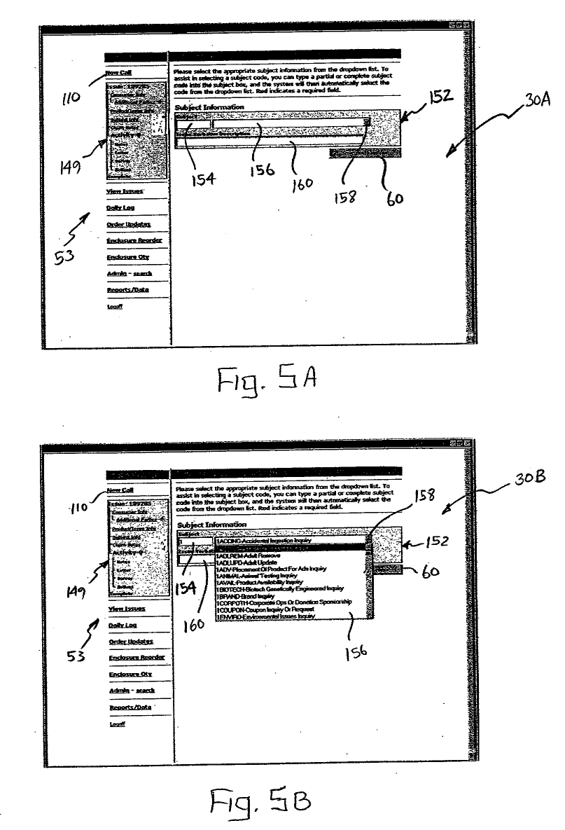

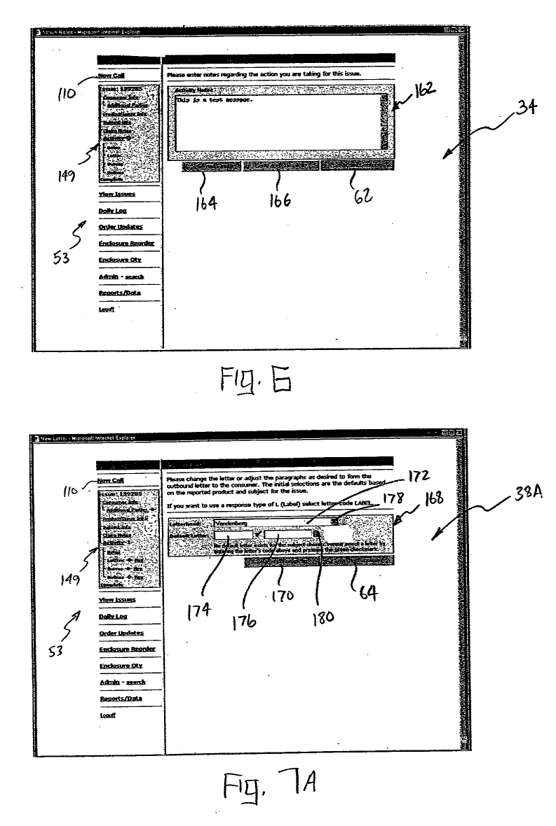

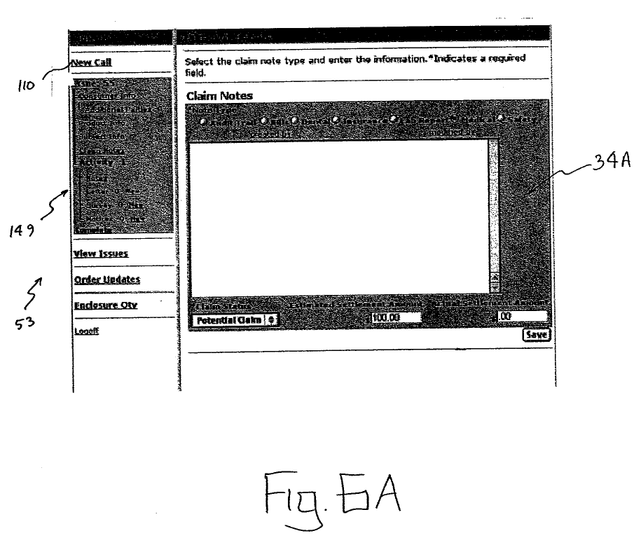

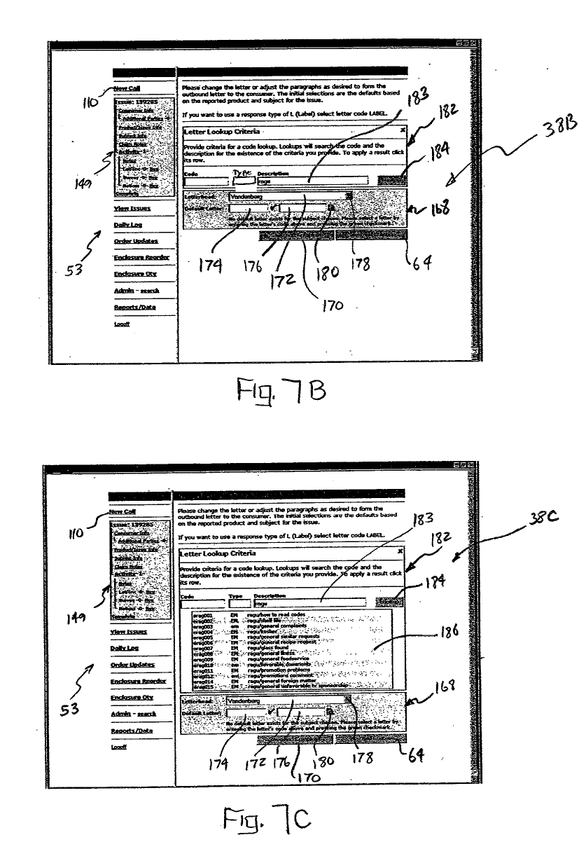

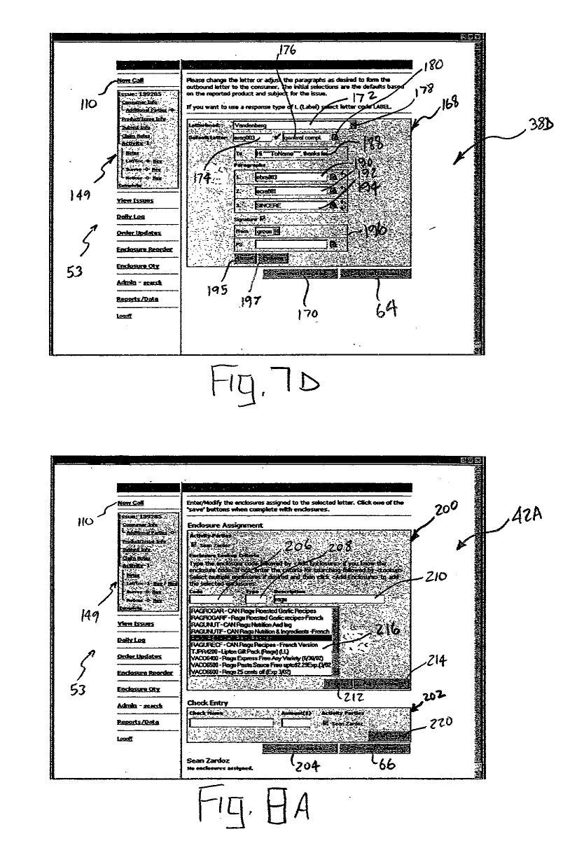

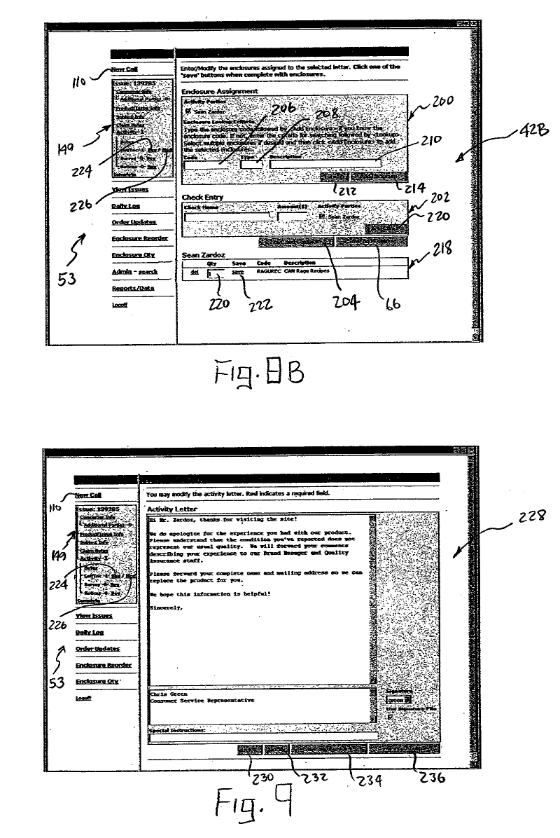

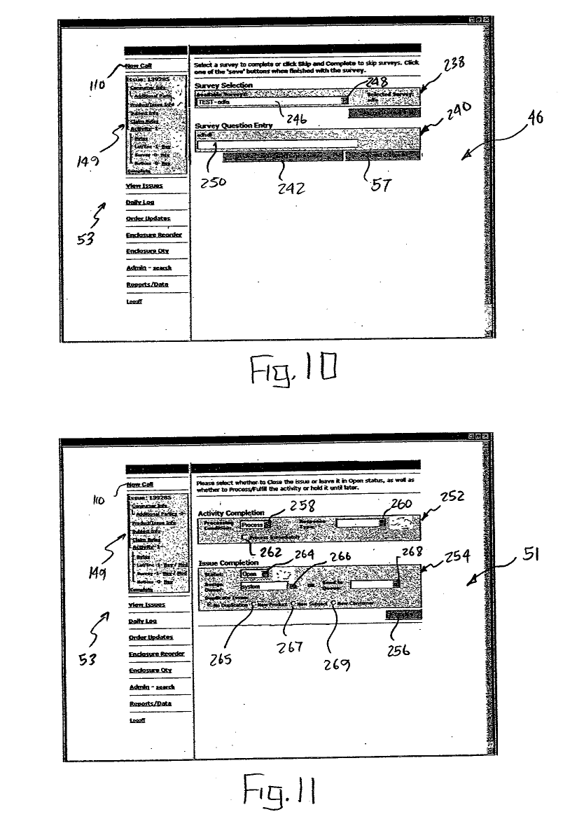

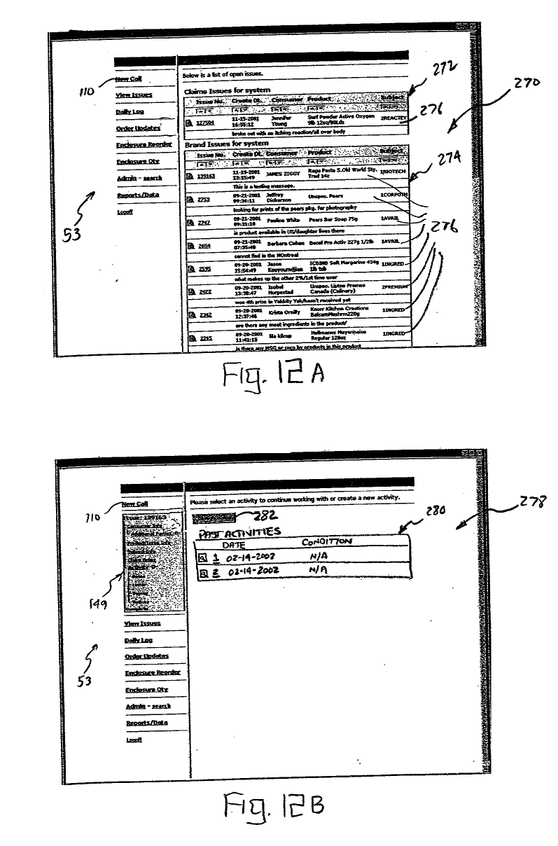

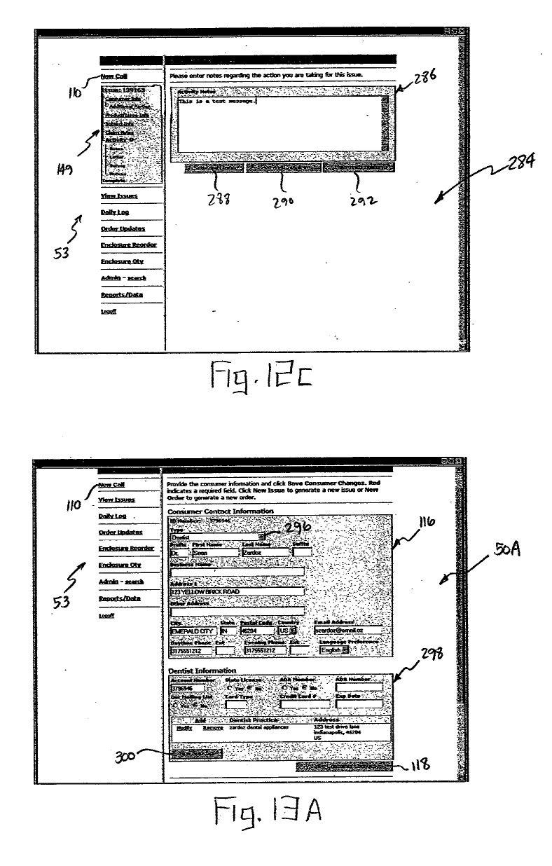

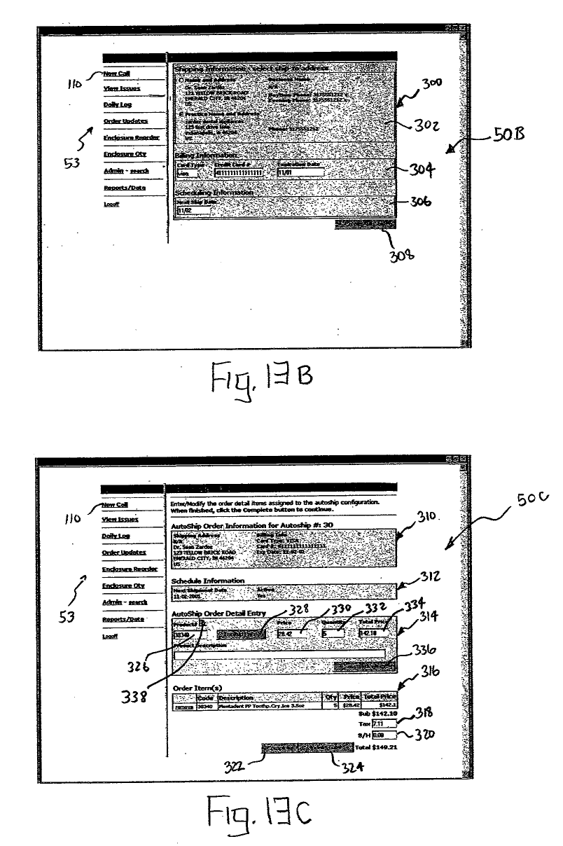

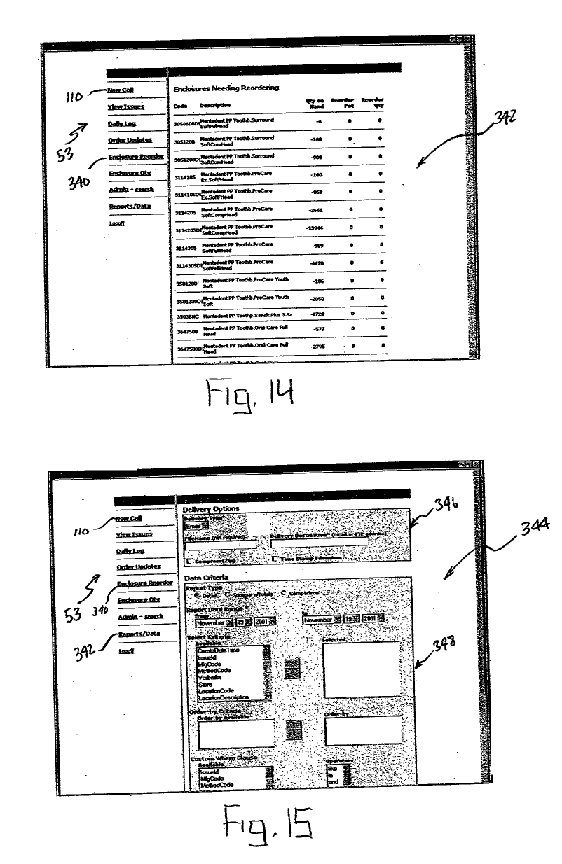

FIG. 1 depicts various components of a system for receiving consumer contacts, storing information relating to the contacts, and arranging for the completion of activities to address issues raised as a result of the contacts. System 10 generally includes a contact processing environment 12 coupled through a network 14 to a server 16. It should be understood that while certain portions of the software described below are described as operating on contact processing environment 12 or server 16, any distribution of the software portions between environment 12 and server 16 is within the ability of one of ordinary skill in the art. Contact processing environment 12 includes a plurality of software routines for generating a plurality of corresponding screens on a terminal or personal computer (not shown) configured to access server 16 via network 14. While the various routines are shown in FIG. 1 within contact processing environment 12, in one embodiment of the invention, the routines may be stored in association with server 16 and accessed via network 14. As indicated above, it is within the ability of a skilled artisan to configure system 10 such that some or all of the routines are application software resident on a computer associated with contact processing environment 12.

More specifically, call processing environment 12 includes an identification routine 18 for generating identification screens 20 or linking to an order screen 50 (described below), an identification look-up routine 22, a product routine 24 for generating product screens 26, a product look-up routine 27, a subject routine 28 for generating subject screens 30, an activity routine 32 for generating an activity screen 34, a letter routine 36 for generating letter screens 38, a letter look-up routine 39, an enclosure routine 40 for generating enclosure screens 42, an enclosure look-up routine 43, a survey routine 44 for generating survey screens 46, a survey look-up routine 47, a completion routine 49 for generating a completion screen 51, an order routine 48 for generating an order screen 50, an order look-up routine 55, and a navigation routine 52 for generating a navigation director display 53.

As will be described in greater detail below, identification screen 20 includes a new issue button 54 and an order button 54A, product screen 26 includes a continue button 58, subject screen 30 includes a continue button 60, activity screen 34 includes a continue button 62, letter screen 38 includes a continue button 64, enclosure screen 42 includes a continue button 66, survey screen 46 includes complete button 57, and completion screen 51 includes a complete button 59. Additionally, product routine 24 generates issue summaries 68 and subject routine 28 modifies issue summaries 68. Activity routine 32 generates activity files 70 and letter routine 36 and enclosure routine 40 modify activity files. As is also described in greater detail below, an operator 78 interacts with call processing environment 12 upon receiving a contact which may be a telephone call or an e-mail over a network 80 from a consumer 82. Network 80 may be, for example, a telephone network, the Internet, an intranet, or some combination thereof. It should be understood that while a single operator 78 is shown for simplicity, a plurality of operators 78 may simultaneously interact with system 10 via a plurality of call processing environments 12 all coupled to network 14.

Network 14 may also include a telephone network, the Internet, an intranet, or some combination thereof. In order to simply this description, and without intending to limit the scope of the present invention, network 14 will be described herein as including the Internet. System 10 may further include a website 84 operated by server 16 on network 14. A plurality of parties in addition to operator 78 may have access to various aspects of system 10 via network 14. Two other parties 86, 88 are shown in FIG. 1, each accessing network 14 via a web browser 90, 92, respectively.

Server 16 generally includes an inventory management routine 76, a report routine 94 and a database 96. As will be further explained below, server 16 may generate print files 72 including reports from report routine 94, letters from letter routine 36, etc. Print file 72 is shown as a file transferred over network 14 to a fulfillment center 74. Of course, print files 72 may be routed to various locations (with or without the use of network 14), such as to a printer location associated with server 16.

In order to provide context for a more detailed description of the operation of embodiments of the present invention provided in association with the description of FIGS. 3A-15, a generalized description of the operation of system 10 is first provided below. In general, consumer 82 contacts operator 78 over network 80 to discuss an issue relating to a product or service. While the term product is used throughout this specification and in the claims, it is intended to include both products and services. Operator 78 logs into system 10 by providing a user identification and password according to well-known principles of secured access. Operator 78 then accesses identification routine 18 which generates identification screens 20. Operator 78 attempts to obtain identification information such as name, address, telephone number, etc. from consumer 82, and inputs the consumer identification information into system 10 via an input device such as a keyboard, microphone, touch screen, mouse, etc. Operator 10 may use identification look-up routine 22 after a portion of the consumer identification information is inputted into system 10. Identification lookup routine 22 communicates with server 16 via network 14 to access database 96 to identify previously stored consumer identification information corresponding to the consumer identification information inputted by operator 78. All matching consumer identification information, or a message indicating that no matches were found, is then displayed to operator 78. Operator 78 may select from the matching consumer identification information which prefills various fields provided by identification screens 20. If no matches are found, operator 78 may obtain more detailed consumer identification information from consumer 82 and transfer the consumer identification information to server 16 via network 14 for storage in database 96. Otherwise, operator 78 may continue through the contact processing sequence by indicating that the identification of consumer 82 is unknown. After consumer 82 is identified, system 10 displays to operator 78 a history of previous contacts associated with consumer 82 as is further described below.

If consumer 82 is calling to order a product, operator 78 may activate order button 54A to jump to order routine 48, the operation of which is described in detail below.

When operator 78 exits identification routine 18 by activating new issue button 54, product routine 24 is automatically evoked. Product routine 24 generates product screens 26 which permit operator 78 to input information relating to the product that is the subject of the current contact from consumer 82. When operator 78 activates continue button 58, issue summary 68 is generated and subject routine 28 is automatically evoked. Subject routine 28 generates subject screens 30, which enable operator 78 to input a description of the issue that is the subject of the present contact from consumer 82. For example, consumer 82 may have a question regarding the product, a complaint regarding the product, or a comment regarding the product. When the issue description is complete and operator 78 activates continue button 60, issue summary 68 is updated and transferred via network 14 to server 16 for storage in database 96 as is further described below.

Activation of continue button 60 also automatically evokes activity routine 32, generating activity screen 34. By interacting with activity screen 34, operator 78 may select or define any of a variety of different activities which should be carried out in order to address the issue raised by consumer 82. For example, if operator 78 is unable to answer a question from consumer 82, operator 78 may define the activity as obtaining an answer to the question. As additional examples, operator 78 may define the activity as sending a letter to consumer 82, providing a coupon or refund check to consumer 82, recording the fact that consumer 82 may file a product liability or other claim against an entity associated with the product, or following up with a party responsible for an issue associated with a related, previously generated activity. Any such activity or multiple activities are defined in activity file 70. When operator 78 activates continue button 62, activity file 70 is transferred via network 14 to server 16 for storage in database 96.

Since many contacts are at least partially addressed by forwarding a letter to consumer 82, activation of continue button 62 on activity screen 34 also automatically evokes letter routine 36. Letter routine 36 generates letter screens 38, which, as is further described below, enable operator 78 to compose a letter related to the issue. Such letters may simply acknowledge the contact, provide explanatory information relating to the product, enclose coupons or checks, etc. If operator 78 desires to include an enclosure, operator 78 may activate continue button 64 to evoke the enclosure routine 40 to generate enclosure screens 42. By interacting with enclosure screens 42, operator 78 can define the enclosure to accompany the letter. This enclosure information may be routed to server 16 and through inventory management routine 76 which generally keeps track of the available quantities of the various possible enclosures (i.e., coupons, etc.) that are maintained at a fulfillment site. The enclosure quantity information is stored in database 96.

When operator 78 activates continue button 66, survey routine 44 is automatically evoked to generate survey screens 46. In appropriate circumstances, operator 78 may then pose survey questions displayed on survey screens 46 to consumer 82, the answers to which are transferred via network 14 to server 16 for storage in database 96. When operator 78 activates complete button 57, completion routine 49 is automatically evoked to generate completion screen 51. By interacting with completion screen 51, operator 78 can assign responsibility for issue summary 68.

Activity file 70 is stored in database 96. If completion of an activity included in an activity file 70 requires sending a letter to consumer 82, transfer of activity file 70 to server 16 may result in the creation of print file 72 which includes enclosure information and is transferred to fulfillment center 74 that prints the letter, includes the enclosure (if any), and sends the letter to consumer 82. It should be understood that a plurality of letters may be included in print file 72 in any of a variety of formats for group printing using conventional printing equipment.

During the above-described automatic call flow sequence, navigation routine 52 displays to operator 78 a plurality of navigation links (navigation director 53) that permit operator 78 to switch between the various routines without regard to the automatically generated call flow sequence. When operator 78 deviates from the automatic sequence using navigation director 53, system 10 may automatically generate the remainder of the sequence depending upon the operator's selection, or require operator 78 to manually direct the remainder of the call processing.

Operator 78 may also use navigation director 53 to access order routine 48 which generates order screen 50. By interacting with order screen 50 as further described below, operator 78 may input product order information obtained from consumer 82 or generate automatic order shipments to consumer 82. This order information is then transferred via network 14 to server 16 for storage in database 96.

FIG. 2 depicts a manner in which issue and activity information is stored in database 96. As indicated above, each contact from consumer 82 results in the creation of an issue summary 68 that is associated with consumer identification information identifying consumer 82. An issue summary 68 may simply consist of a note that consumer 82 called to compliment a product. Alternatively, issue summary 68 may include a description of a question from consumer 82 that was answered by operator 78. In any event, an activity file 70 is created (even if no further activity is required) to close the issue and record the fact that a contact was processed for billing or other purposes. An activity file 70 or multiple activity files 70 may be created and associated with the corresponding issue summary 68 which, in turn, is associated with a party or parties responsible for completing one or more of the activities associated with issue summary 68. FIG. 2 is a conceptual diagram of the organization of this information is in database 96.

As shown, database 96 includes a plurality of consumer identifiers 100_{A},100_{B}, 100_{N} that include or are associated with consumer identification information relating to a particular consumer 82. All issue summaries 68 and activity files 70 associated with a particular consumer 82 are linked to the consumer identifier 100_{A}, 100_{B}, 100_{N}corresponding to the consumer 82. As shown, associated with each consumer identifier 100_{A}, 100_{B}, 100_{N} is an issue history 102_{A}, 102_{B}, 102_{N}. Each issue history 102_{A}, 102_{B}, 102_{N} may include a plurality of issue summaries 68 resulting from multiple contacts with consumer 82.

FIG. 2 also depicts a plurality of parties 106_{A}, 106_{B}, 106_{N}, which may include operators 78 and other parties 86, 88 as shown in FIG. 1. Of course, database 96 may include a very large number of consumer identifiers 100_{A}, 100_{B}, 100_{N}, issue histories 102_{A}, 102_{B}, 102_{N}, and corresponding parties 106_{A}, 106_{B}, 106_{N}. Only three of each of these items is shown in FIG. 2 for simplicity.

As will be further described below, whenever an issue summary 68 is generated, operator 78 may either retain responsibility for issue summary 68 or forward issue summary 68 to another party, thereby assigning responsibility for issue summary 68 to the other party. When issue summary 68 is forwarded to another party, database 96 indicates that the party is responsible for the issue summary 68 as represented by the dotted lines in FIG. 2. Alternatively, operator 78 may forward an issue summary 68 to one of a plurality of queues 108_{A}, 108_{N} included in database 96. Parties 106_{A}, 106_{B}, 106_{N} may be associated with one or more of the plurality of queues 108_{A}, 108_{N}. As will be further described below, a party 106_{A}, 106_{B}, 106_{N} associated with the queue 108_{A}, 108_{N} may view issue summaries 68 contained in queue 108_{A}, 108_{N} or accept responsibility for an issue summary 68 contained in queue 108_{A}, 108_{N}

As should be apparent from FIG. 2, multiple parties 106_{A}, 106_{B}, 106_{N} may be responsible issue summaries 68 associated with a single consumer identifier 100_{A}, 100_{B}, 100_{N}. For example, parties 106_{A} and 106_{B} are responsible for issues summaries 68_{A2}, 68_{AN} stored in database 96 in issue history 102_{A}. FIG. 2 also illustrates a situation where more than one activity file 70 is associated with or linked to an issue summary 68. As indicated above, party 106_{A} is responsible for issue summary 68_{A2} which is associated with two activity files 70_{A1A}, 70_{AE1B}. Of course, a single party 106_{A}, 106_{B}, 106_{N} may be responsible for issue summaries 68 of multiple consumer identifiers 100_{A}, 100_{B}, 100_{N}. In the case of party 106_{B}, issue summary 68_{AN} is associated with consumer identifier 100_{A} and issue summary 68_{B1} is associated with consumer identifier 100_{B}. It should be noted that a party 106_{A}, 106_{B}, 106_{N} may obtain responsibility for an issue summary 68, complete an activity associated with an activity file 70, and then assign responsibility for the issue summary 68 to another party 106_{A}, 106_{B}, 106_{N}.

Referring now to FIGS. 3A-C, when consumer 82 contacts operator 78, operator 78 may log into system 10 and evoke consumer identification routine 18 which generates identification screens 20A-C. Identification screen 20A may be evoked by clicking on new call link 110 of navigation director 53. As shown in FIG. 3A, identification screen 20A presents operator 78 with a plurality of blank identification fields in a consumer criteria box 112. In this example, it is assumed that operator 78 obtained from consumer 82 the last name of consumer 82. Operator 78 inputs the last name into last name field 114 of consumer criteria box 112 and activates search button 56. Activation of search button 56 evokes identification look-up routine 22 which uses the inputted information as search criteria to search database 96 for matching consumer information. Specifically, identification look-up routine 22 determines whether any of consumer identifiers 100_{A}, 100_{B}, 100_{N} include consumer identification information containing a last name corresponding to the inputted last name. If a match is found, all of the consumer identification information corresponding to each matched consumer identifier 100_{A}, 100_{B}, 100_{N} is displayed to operator 78. Operator 78 selects the appropriate matched consumer identifiers 100_{A}, 100_{B}, 100_{N}. Operator 78 may verify the consumer identification information corresponding to consumer 82 by, for example, reciting the displayed address and asking consumer 82 whether the recited address is correct.

The selected consumer identification information automatically populates consumer contact box 116 of identification screen 20B shown in FIG. 3B. Alternatively, if no match was found as a result of executing identification look-up routine 22, operator 78 may click on new consumer button 117 which causes identification routine 18 to generate identification screen 20B as shown in FIG. 3B. Operator 78 then obtains from consumer 82 information to fill-in the blank fields of consumer contact information box 116. In either event, operator 78 then activates save consumer changes button 118 which causes identification routine 18 to generate identification screen 20C as shown in FIG. 3C. Additionally, if new consumer button 117 was activated, identification routine 18 transmits the consumer identification information inputted into consumer contact information box 116 via network 14 to server 16 for storage in database 96 in association with a new consumer identifier 100_{A}, 100_{B}, 100_{N}.

It should be noted that if consumer identification information is found in database 96 as a result of activation of identification look-up routine 22, and that consumer identification information is selected to automatically populate consumer contact information box 116, then identification screen 20B further includes a display of issue history 102_{A}, 102_{B}, 102_{N} associated with the matched consumer identifier 100_{A}, 100_{B}, 100_{N}. Accordingly, operator 78 has the ability to review issue summaries 68 contained in the displayed issue history 102_{A}, 102_{B}, 102_{N} to immediately determine the sequence of past contacts with consumer 82. This issue history information is displayed in issue history box 120 shown in FIG. 3C. As is also shown in FIG. 3C, a similar display of a history of products ordered by consumer 82, if any, is displayed in order history box 122. If an issue history 102_{A}, 102_{B}, 102_{N} is displayed in issue history box 120, operator 78 may select from one of the displayed issue summaries 68 upon determining that consumer 82 is contacting operator 78 to discuss or further process a previously generated issue summary 68. Alternatively, operator 78 may activate new issue button 54, evoking product routine 24 which generates product screens 26A-D as shown in FIGS. 4A-D.

When presented with product screen 26A of FIG. 4A, operator 78 determines from consumer 82 the product about which consumer 82 is calling. Operator 78 may then enter a UPC code in field 126 of product assignment box 128. Alternatively, if operator 78 does not know the UPC code corresponding to the product, operator 78 may activate magnifying glass icon 130 to cause product routine 24 to generate product screen 26B shown in FIG. 4B. As shown, screen 26B includes product lookup criteria box 132 which provides operator 78 with blank fields 134, 136, 138 in which to input search criteria for the product. In this example, operator 78 typed in the word “ragu” in description field 138 of product look-up criteria box 132. Operator 78 may then activate look-up button 140 which evokes product look-up routine 27 (FIG. 1). Look-up routine 27 uses the inputted information (i.e., “ragu”) to search product information stored in database 96 for matching products. The results of the look-up are displayed in product look-up criteria box 132 on product screen 26C as shown in FIG. 4C. By selecting the appropriate product displayed in look-up results box 142 of product look-up criteria box 132, operator 78 will cause product routine 24 to automatically fill UPC code field 126 of product assignment box 128.

Product screen 28D of FIG. 4D is then displayed with UPC code field 126 populated with the selected UPC code corresponding to the selected product. Operator 78 then activates look-up location button 144 which causes product routine 24 to access database 96 to determine the location of the manufacturer of the product corresponding to the selected UPC code. If a manufacturer is found, this information will be used to automatically populate the fields shown in product assignment box 128 of FIG. 4D.

Referring again to FIG. 4D, operator 78 can select from various options displayed in method type field 146 of issue information box 148 by clicking on the pull-down menu button 150. These options describe the method by which consumer 82 is contacting operator 78 and may include a variety of different options including by telephone, e-mail, letter, or web call via an icon (not shown) displayed on website 84. After a contact method is selected, operator 78 activates save and continue button 58, automatically evoking subject routine 28 which generates subject screens 30A-B as shown in FIGS. 5A-B. Product routine 24 also automatically generates an issue summary 68 containing the information relating to the contact that has been collected thus far in the processing. Issue summary 68 is transferred via network 14 for storage in database 96. From this point forward, the system updated issue summary 68 during further processing of issue summary 68 to indicate who accessed, modified, or otherwise processed issue summary 68, and when such activity occurred. This “audit trail” is accessible via operator or other party issue screens as described herein. It should be noted that at this point in the automatic call flow sequence, navigation routine 52 generates an issue box 149 within navigation director 53 to permit operator 78 to reactivate identification routine 18 or product routine 24 to make changes or additions to the previously defined information. For example, operator 78 may add more information or additional parties relating to an issue summary 68 resulting from the contact such as a doctor, lawyer, etc.

Subject screen 30A includes a subject information box 152 with a subject code field 154, a menu field 156, a pull-down menu button 158, and an issue verbatim description field 160 as well as save and continue button 60. If, after discussing the issue with consumer 82, operator 78 knows an appropriate subject code, operator 78 may enter that code information into subject code field 154. In this example, operator 78 knows that the code begins with the numeral 1. Upon typing the numeral 1 in subject code field 154, the highlight bar of menu field 156 moves to the first subject code matching the entered character as shown on screen 30B of FIG. 5B. Operator 78 may then choose from a displayed subject code or continue typing. Alternatively, if operator 78 does not know the appropriate subject code, operator 78 may click on pull-down menu button 158 associated with menu field 156 to generate a pull-down menu including all available subject codes. Operator 78 may then scroll through the menu and select the appropriate code. Once a subject code is entered, operator 78 may type a description of the issue relating to the selected product in issue verbatim description field 160.

At this point, consumer 82 is identified, the product is identified, and the issue is identified. Accordingly, an issue summary 68 containing this information has been generated and transferred via network 14 to server 16 for storage in database 96 as shown in FIG. 1. Specifically, issue summary 68 has been stored in an issue history 102_{A}, 102_{B}, 102_{N} corresponding to the consumer identifier 100_{A}, 100_{B}, 100_{N} created or identified at the beginning of the above-described process.

When operator 78 activates save and continue button 60 of subject screen 30B, activity routine 32 is automatically evoked, generating activity screen 34 as shown in FIG. 6. Activity screen 34 includes an activity notes box 162, a save and claim button 164, a save and complete button 166, and save and continue button 62. Operator 78 may type in a full description of an activity to be completed in conjunction with the issue raised by consumer 82. After the message is composed, operator 78 may activate one of the three buttons 164, 166, 62 depending upon the nature of the issue. If consumer 82 has indicated that a potential exists for a legal claim against a manufacturer of the product, operator 78 would input a full description of the comments from consumer 82 in activity notes box 162 and activate save and claim button 164. Activity routine 32 then generates an additional screen (screen 34A of FIG. 6A) that allows operator 78 to further describe the nature, status, and any settlement amounts associated with the claim. This information is stored in activity file 70 and is associated with the current issue summary 68 which operator 78 may forward to the legal department by transmitting issue summary 68 to a queue 108_{A}, 108_{N} associated, for example, with a legal department of a call processing center.

If operator 78 activates save and complete button 166, system 10 displays screen 51 as shown in FIG. 11, which permits operator 78 to either process or hold the activity, as well as assign responsibility for completion of the issue summary 68 as will be further described below. If, on the other hand, operator 78 activates save and continue button 62, the automatic sequence of the call processing flow continues. Specifically, activity routine 32 evokes letter routine 36 which generates letter screens 38 A-D as shown in FIGS. 7A-D. As indicated above, many contacts require a letter of some type as follow-up to the contact. Accordingly, the default call flow of an embodiment of the invention includes the letter creation sequence described below.

Letter screen 38A of FIG. 7A includes form letter box 168, save and complete button 170, and save and continue button 64. Form letter box 168 includes a letterhead field 172, a default letter field 174, and a default letter menu field 176. Based on the previously entered product and issue information, system 10 may automatically populate letterhead field 172 with an appropriate letterhead type. Alternatively, operator 78 may activate a drop-down menu button 178 to select a particular style or type of letterhead. Operator 78 may then input into default letter field 174 a description of the default letter type appropriate for responding to the present issue. If operator 78 does not know the code or description of the default letter, operator 78 may activate the magnifying glass icon 180 adjacent default letter menu field 176 to search for an appropriate letter. Upon activating magnifying glass icon 180, letter routine 36 generates letter screen 38B as shown in FIG. 7B. Letter screen 38B includes a letter look-up criteria box 182 in addition to default letter box 168. In a manner similar to that described above with respect to looking up a product, letter look-up criteria box 182 includes fields relating to a default letter and a look-up button 184. In this example, operator 78 typed in the word “ragu” in description field 183 of letter look-up criteria box 182 and activated look-up button 184. This evokes letter look-up routine 39 (FIG. 1) which uses the inputted information as search criteria and searches default letters stored in database 96 for letters including the word “ragu” in the description of the letter. As shown in FIG. 7C, screen 38C is generated wherein letter look-up criteria box 182 is enlarged to include a display of the matching default letters (i.e., in area 186). Operator 78 then selects the appropriate letter from the list.

When a letter is selected, letter routine 36 generates letter screen 38D as shown in FIG. 7D. In addition to letterhead field 172, default letter field 174, and default letter menu field 176, default letter box 168 of screen 38D includes a greetings field 188, paragraph fields 190, 192, 194, a signature box 196, a reset button 195, and a preview button 197. From screen 38D, operator 78 can modify the various fields to customize the default letter, activate preview button 197 to preview the letter, or activate reset button 195 to clear the various fields described above. It should be noted that the level of permissions available to operator 78 (established based on the identification of operator 78 at login into system 10) will determine which default letters are available to operator 78 and which signatures will be required for the various default letters. If operator 78 activates save and complete button 170 of letter screen 38D, then completion screen 51 shown in FIG. 11 is displayed to permit operator 78 to complete processing of the contact as is further described below.

If operator 78 activates save and continue button 64, then letter routine 36 automatically evokes enclosure routine 40. Enclosure routine 40 generates enclosure screen 42A as depicted in FIG. 8A. Screen 42A includes an enclosure assignment box 200, a check entry box 202, a save and complete button 204, and save and continue button 66. Enclosure assignment box 200 includes enclosure code field 206, enclosure type field 208, enclosure description field 210, look-up button 212, and add enclosure button 214. If operator 78 knows the enclosure code for the enclosure operator 78 desires to include with the letter composed as described above, operator 78 inputs the enclosure code in enclosure code field 206. Alternatively, operator 78 may search for an appropriate enclosure by, for example, inputting a word in enclosure description field 210 and activating look-up button 212. In this example, operator 78 inputted the word “ragu” in enclosure description field 210. By activating look-up button 212, enclosure routine 40 evokes enclosure lookup routine 43 which accesses database 96 to retrieve information associated with the available enclosures that include the word “ragu” in the description. Enclosure routine 40 displays the matches in area 216 as shown in FIG. 8A. Operator 78 highlights the desired enclosure (or holds down the control key and highlights and selects multiple enclosures) and activates add enclosure button 214.

Enclosure routine 40 then generates enclosure screen 42B as shown in FIG. 8B. As shown, an enclosure box 218 is displayed in addition to enclosure assignment box 200 and check entry box 202. Operator 78 may change the default quantity of enclosures displayed in the quantity field 220 of enclosure box 218 and save the changed quantity by activating save link 222. When operator 78 has added all desired enclosures in this manner, operator 78 may activate save and complete button 204 to evoke continue screen 51 of FIG. 11 as described below. Alternatively, operator 78 may activate add check button 220 of check entry box 202 and follow a similar procedure to define a check memo and check amount to be enclosed with the letter composed as described above. If no check is desired, operator 78 may activate save and continue button 66.

It should be noted that director 53 includes a new link 224 and a modify link 226 in association with a letter generated as a result of the above-described call flow process. Operator 78 may activate modify link 226 to review the letter as composed, make modifications as necessary, or delete the letter entirely. For example, if additional parties are associated with the issue, activation of modify link 226 permits changes to the distribution features of the letter (i.e., who is the primary recipient and who is to receive copies of the letter). Activating modify link 226 generates letter review screen 228 as shown in FIG. 9. Various aspects of the letter are displayed in screen 228 which also includes a delete button 230, a modify button 232, a save and complete button 234, and a save and continue button 236. Operator 78 may activate delete button 230 to delete the letter entirely. Operator 78 may alternatively activate modify button 232 to access the text of the letter or the other various fields to make any necessary changes. Operator 78 may also activate save and complete button 234 to evoke completion screen 51 as shown in FIG. 11 and described below. By activating save and continue button 236, operator 78 returns to enclosure screen 42B shown in FIG. 8B.

When operator 78 activates save and continue button 66 of screen 42B, enclosure routine 40 automatically evokes survey routine 44 which generates survey screen 46 as shown in FIG. 10. Survey screen 46 includes a survey selection box 238, a survey question entry box 240, a save survey and begin another button 242, and a save and complete button 57. Operator 78 may type in a name of a survey to present to consumer 82 in available surveys field 246 of survey selection box 238. Alternatively, operator 78 may activate pull-down menu button 248 in survey selection box 238 to view a list of available surveys. When a survey is selected, survey routine 44 generates survey questions in survey question entry box 240. Operator 78 poses the questions to consumer 82 and inputs the responses in survey question answer field 250. Operator 78 may save the responses to the survey in database 96 and begin another survey by activating the save survey and begin another button 242. Alternatively, operator 78 may save the responses to the survey in database 96 and complete processing of the contact by activating save and complete button 57 of survey screen 46.

Activation of save and continue button 57 causes survey routine 44 to automatically evoke completion routine 49. Completion routine 49 generates completion screen 51 (as shown in FIG. 11) which includes an activity completion box 252, an issue completion box 254, and complete button 59. Activity completion box 252 includes a processing condition menu button 258, a response type menu button 260, and a process immediately selection box 262. Issue completion box 254 includes a status menu button 264, an assign owner magnifying glass icon 266, and a queue menu button 268, a new product radio button 265, a new subject radio button 267, and a new consumer radio button 269. By activating processing condition menu button 258, operator 78 can select between holding an activity or processing an activity. Operator 78 may activate response type menu button 260 to select from a pull-down menu the correct response type. It should be noted that only appropriate response types based upon the previously entered information will be provided in the pull-down menu (not shown). The response type is an indication of how the activity is to be completed or fulfilled. For example, it may indicate (to a fulfillment center) the type of print stock to be used for a letter, the enclosure specifications, or whether a check is to be enclosed. Operator 78 may indicate that the activity must be processed immediately by clicking on process immediately field 262. Additionally, operator 78 may activate status menu button 264 to select between available predefined status indicators (i.e., open or closed). Finally, operator 78 may assign ownership of an issue summary 68 by selecting among a variety of available individual owners (i.e., other operators 78 or other parties 86, 88) by activating assign owner magnifying glass icon 266.

If operator 78 assigns ownership of an issue summary 68 to another party, issue summary 68 is transferred via network 14 to server 16 for storage in database 96 and associated with the other party. Also, operator 78 may assign ownership of an issue summary 68 to a queue 108_{A}, 108_{N} by selecting from a send queue menu displayed by activating queue menu button 268. In that event, issue summary 68 is transferred to database 96 for association with a queue 108_{A}, 108_{N} corresponding to a selected queue. Parties 106_{A}, 106_{B}, 106_{N} associated with or responsible for issue summaries 68 associated with the selected queue 108_{A}, 108_{N} (for example, employees of a lab responsible for testing products or members of a legal department responsible for handling claims relating to products) have access to either view issue summary 68 or obtain ownership and responsibility for the completion of issue summary 68. When operator 78 activates complete button 59, completion routine 49 automatically evokes identification routine 18 which generates identification screen 20A of FIG. 3A to permit operator 78 to process another contact.

Radio buffons 265, 267, and 269 of issue completion box 254 provide access to various issue duplication features for more convenient processing of contacts having similar data. More specifically, activation of new product radio button 265 causes the system to jump to product routine 24, but retains all of the previously entered information relating to consumer 82 (and any previously defined additional parties). Activation of new subject radio button 267 causes the system to jump to subject routine 28, but retains all of the previously entered information relating to consumer 82 and the product. This feature permits operator 78 to process, for example, two issues from a single consumer 82 relating to the same product (e.g., product X was spoiled (issue #1) and contained in a defective jar (issue #2)). Similarly, activation of new consumer button 269 generates a new issue that retains all of the previously entered information relating to the product and the issue (even duplicating any letters associated with the previous issue), but setting the consumer to unknown. When operator 78 sets new consumer information, all of the remaining information relating to the product and subject is pre-filled. This feature facilitates more efficient processing of contacts from multiple consumers relating to the same product and the same issue.

FIG. 12A shows an issue screen 270 that is generated by system 10 for display to operator 78 or another party 86, 88 that has access to login to system 10. Immediately after login, issue screen 270 is presented to provide a list of issue summaries 68 having associated activity files 70 for which the party logging in is responsible. Issue summaries 68 are separated into potential claim issues and product issues. Accordingly, issue screen 270 includes a claims issue box 272 and a product issue box 274. Operator 78 may select any issue listing 276 by activating the issue number link associated with the issue listing 276. When an issue is selected, operator 78 may continue to process the issue. Operator 78 may, alternatively, click on the magnifying glass icon included in the issue listing 276 to view a display of the issue summary 68 associated with the issue listing 276. Issue summary 68 will include consumer identification information obtained during the contact that generated the issue, product, subject information, and activity information, a listing of activities associated with the issue summary, and any letters and enclosures associated with the activities.

After operator 78 selects an issue listing 276 by activating the issue number link, system 10 generates screen 278 of FIG. 12B which provides a listing of activities associated with the issue summary 68 in a past activities box 280. By selecting the number link associated with a listed activity, previous activity notes from the associated activity file 70 are displayed to operator 78. Alternatively, operator 78 may activate new activity button 282 to create a new activity associated with the selected issue summary 68. Activation of new activity button 282 results in the generation of screen 284 (FIG. 12C) that includes an activity notes box 286, a save and claim button 288, a save and complete button 290, and a save and continue button 292. Operator 78 may enter notes related to the new activity in activity notes box 286, and activate save and continue button 292. Save and continue button 292 evokes letter routine 36 which generates a letter screen similar to letter screen 38D of FIG. 7D. The prefilled information of letter screen 38D is obtained from the previously entered or selected information associated with the previously generated activity file 70. If operator 78 instead activates save and complete button 290, completion routine 49 is evoked to generate completion screen 51, which operator 78 uses to finish processing the activity in the manner described above. Finally, if operator 78 activates save and claim button 288, a screen (not shown) is presented to enable operator 78 to input a description of the potential claim, the claim status, and an estimated and actual settlement amount.

FIG. 13A illustrates a screen associated with a product ordering feature of the present invention (specifically, the automatic shipment feature). Screen 50A is similar to screen 20B of FIG. 3B in that it includes consumer contact information box 116. The software of the present invention may be configured such that certain types of consumers may be authorized to order products directly by contacting operator 78. Upon receiving a contact, operator 78 may activate consumer type menu button 296 to select a consumer type from a pull-down menu. Various types of consumers may be defined. Dentists are used in the present example. The software of the present invention is configured such that when operator 78 selects dentist type in consumer contact information box 116, a dentist information box 298 is displayed wherein further information regarding the account and billing information corresponding to the dentist (consumer 82) may be entered or modified.

By activating the new auto ship button 300 of dentist information box 298, operator 78 causes order routine 48 to generate order screen 50B as shown in FIG. 13B. Order screen 50B includes a shipping information box 300. Shipping information box 300 includes a ship to address area 302, a billing information area 304, and a scheduling information area 306. Order screen 50B further includes a create autoship button 308. Operator 78 may select a ship to address from one or more previously generated ship to addresses displayed in ship to address area 302, create or modify billing information displayed in billing information area 304, and define a next ship date in scheduling information area 306.

By activating create autoship button 308, operator 78 causes order routine 48 to generate order screen 50C as shown in FIG. 13C. Order screen 50C includes an autoship order information box 310, a scheduling information box 312, an autoship order detail entry box 314, an order items box 316, a tax field 318, a shipping and handling field 320, a complete button 322, and an update totals button 324. Autoship order information box 310 displays the previously defined ship to address and billing information. Scheduling information box 312 displays the previously defined next shipment date information. Autoship order detail entry box 314 includes a product code field 326, a look-up price button 328, a price field 330, a quantity field 332, a total price field 334, a save order item button 336, and a products magnifying glass icon 338. Operator 78 may type in a product code in product code field 326 and activate look-up price button 328 to evoke order look-up routine 55 which accesses database 96 to obtain pricing information for the selected product. Operator 78 may then enter the desired ship quantity in quantity field 332, causing order routine 48 to calculate a total price which is displayed in total price field 334. By activating save order item button 336, operator 78 causes order routine 48 to display the product order information in order items box 316. Alternatively, if operator 78 does not know the product code associated with the desired product, operator 78 may activate products magnifying glass icon 338. This causes order routine 48 to evoke order look-up routine 55 which obtains from database 96 a listing of product information (including product codes) of products available for shipment. Operator 78 may select from the displayed products and follow the procedure described above to add a product to the order items box 316. Operator 78 may modify the shipping and handling fee by changing the quantity in shipping and handling field 320. Update totals button 324 causes order routine 48 to re-calculate the total price, tax, and total cost of the order, which is displayed near the bottom of screen 50C. When operator 78 activates complete button 322, the autoship information is transferred from order routine 38 via network 14 to server 16 for storage in database 96. A scheduled routine (e.g., one a day) obtains pending autoship orders and processes them by, for example, forwarding the appropriate w information to a fulfillment center.

Additionally, order routine 48 also processes requests for single orders of products. For example, when operator 78 activates order button 54A of identification screen 20, operator 78 is presented with a series of screens (not shown) that permit operator 78 to specify shipping address, billing information, product description, product number, price, and quantity.

Referring now to FIG. 14, by activating the enclosure reorder link 340 in navigation director 53 in any of the above-described screens, operator 78 causes system 10 to generate an enclosure reorder screen 342. As indicated above, when a letter having an enclosure is processed, the enclosure information is transferred to server 16 and processed by inventory management routine 76. Inventory management routine 76 decrements a quantity on hand number stored in database 96 associated with each enclosure. By maintaining a running inventory of enclosures, inventory management routine 76 can be configured to provide a system administrator or other party with an indication of a need to reorder a particular enclosure when the quantity on hand value of the enclosure falls below a predetermine threshold. Of course, inventory management routine 76 may readily be modified to track other items such as letterhead or other office supplies. Enclosure reorder screen 342 displays to an operator 78 or other party reorder quantities in a report format. System 10 is also configured to permit operators 78 or other parties 86, 88 (referred to collectively as “users”) to request reports based on information stored in database 96. By activating the reports/data link 342 of navigation director 53 and clicking on an issue-ad hoc link (not shown) presented upon activation of reports/data link 342, a user is presented with report screen 344 as shown in FIG. 15. Report screen 344 includes a delivery options box 346 and a data criteria box 348. The user may interface with delivery options box 346 to specify how and to whom the report should be delivered. The various fields of data criteria box 348 permit the user to specify the date range of the report, the type of data to be included in the report, the organization of the data, and other various report criteria according to established database query principles. Report screen 344 further includes a submit request button (not shown). When the user has specified the report content and delivery options, the user may activate the submit request button which causes report routine 94 to generate a report request. Report routine 94 may process the report request by generating, for example, an e-mail containing the report information. The e-mail may be sent via network 14 to the user according to well-established principles. Alternatively, the report may be posted to website 84 at a secure location which is only accessible by the user using conventional ID and password access methods.

It should further be noted that embodiments of the invention include the ability to save report profiles (thereby avoiding repetition) and to schedule report generation events (thereby eliminating the need to periodically re-open and re-generate a report).

The foregoing description of the invention is illustrative only, and is not intended to limit the scope of the invention to the precise terms set forth. Although the invention has been described in detail with reference to certain illustrative embodiments, variations and modifications exist within the scope and spirit of the invention as described and defined in the following claims.

What is claimed is:

1. A program for use on a computer system to assist an operator in processing a contact from a consumer about an issue relating to a product, including:
a first routine for generating a first screen to enable the operator to input information identifying the consumer, the first screen including a first button;
a second routine for responding to activation of the first button by generating a second screen to enable the operator to input information identifying the product, the second screen including a second button;
a third routine for responding to activation of the second button by generating a third screen to enable the operator to input information describing the issue.

2. The program of claim 1 wherein the contact is a telephone call.

3. The program of claim 1 wherein the contact is an e-mail.

4. The program of claim 1 wherein the third screen includes a third button, the program further including a fourth routine for responding to activation of the third button by generating a fourth screen to enable the operator to input information describing an activity to address the issue.

5. The program of claim 4 wherein the activity includes handling a threatened claim relating to the product.

6. The program of claim 4 further including an issue screen corresponding to the operator, the issue screen including issues associated with the operator that remain the responsibility of the operator.

7. The program of claim 6 wherein an issue no longer remains the responsibility of the operator when the operator completes the issue.

8. The program of claim 6 wherein the issue no longer remains the responsibility of the operator when the operator assigns the issue to another party.

9. The program of claim 8 wherein the other party is a lab for performing tests on the product.

10. The program of claim 8 wherein the other party is a legal department for handling claims relating to the product.

11. The program of claim 6 wherein the operator may assign the issue to any of a plurality of other parties, the program further including issue screens corresponding to each of the plurality of other parties, the operator issue screen and the other party issue screens being accessible over a network.

12. The program of claim 11 wherein the network is the internet.

13. The program of claim 6 wherein the issue no longer remains the responsibility of the operator when the operator forwards the issue to a queue.

14. The program of claim 13 wherein a plurality of other parties are responsible for issues in the queue.

15. The program of claim 14 wherein the program enables any of the plurality of other parties to do one of view issues in the queue and take responsibility for issues in the queue.

16. The program of claim 15 wherein any of the plurality of other parties can access the queue using a web browser.

17. The program of claim 4 wherein the fourth screen includes a fourth button, the program further including a fifth routine for responding to the fourth button by generating a fifth screen to enable the operator to create a letter to the consumer regarding the issue.

18. The program of claim 17 wherein the fifth screen includes a fifth button, the program further including a sixth routine for responding to the fifth button by generating a sixth screen to enable the operator to input information describing an enclosure to be included with the letter.

19. The program of claim 18 wherein the sixth screen includes a sixth button, the program further including a seventh routine for responding to the sixth button by generating a seventh screen to enable the operator to input information describing responses of the consumer to survey questions.

20. The program of claim 1 wherein the operator inputs information manually.

21. The program of claim 1 the operator inputs information by selecting information from a list of options.

22. The program of claim 1 wherein the issue is a complaint about the product.

23. The program of claim 1 wherein the issue is a question about the product.

24. The program of claim 4 wherein an activity associated with the issue includes sending a letter to the consumer.

25. The program of claim 24 wherein the letter includes default content based on the information identifying the product and the information describing the issue.

26. The program of claim 25 wherein the operator can modify the default content.

27. The program of claim 25 wherein the operator can modify distribution settings associated with the letter.

28. The program of claim 24 wherein a fulfillment center prints the letter and sends the letter to the consumer.

29. The program of claim 24 wherein the letter includes an enclosure.

30. The program of claim 29 further including an inventory management routine for updating an inventory of enclosures whenever an enclosure is included in a letter.

31. The program of claim 30 wherein the inventory management routine generates a report when the inventory falls below a reorder quantity.

32. The program of claim 24 wherein the enclosure includes a check.

33. The program of claim 24 wherein the letter is generated in digital form as part of a print file.

34. The program of claim 33 wherein a plurality of letters are included in the print file.

35. The program of claim 34 wherein the print file includes a description of enclosures accompanying the letters.

36. The program of claim 1 further including a navigation routine for generating a plurality of navigation links displayed on each of the various screens to enable the operator to evoke any of the various screens from a presently displayed screen.

37. The program of claim 1 wherein the first screen further includes a lookup button activation of which evokes a look-up routine for searching a database containing a plurality of issue histories to identify an issue history associated with the consumer.

38. The program of claim 37 wherein the look-up routine also searches the database to identify an order history associated with the consumer.

39. The program of claim 37 wherein the search routine displays a summary of the consumer issue history to the operator.

40. The program of claim 37 further including a report routine for generating a report including information from the plurality of issue histories.

41. The program of claim 40 wherein the report has an organization and content, a user of the report routine being able to specify the organization and the content of the report.

42. The program of claim 41 wherein the report is described by a report profile, the user being able to save the report profile and schedule periodic report generation events.

43. The program of claim 41 further including a report server configured to receive report requests over a network from users of the report routine.

44. The program of claim 43 wherein the report server is configured to transmit reports to the users via one of e-mail and an ftp site.

45. The program of claim 43 wherein the report server is configured to post reports to a secured web site accessible by the users.

46. The program of claim 1 further including an order routine for generating a screen that enables the operator to input an order from the consumer for a product.

47. The program of claim 46 wherein the order routine calculates a total cost of the order.

48. The program of claim 47 wherein the order routine is configurable to automatically generate an order from a consumer when a predetermined time since a prior order from the consumer has elapsed.

49. The program of claim 1 wherein the second routine generates a first issue summary for storage in a database, the first issue summary including the consumer information and the product information.

50. The program of claim 49 wherein the third routine updates the first issue summary with the issue information.

51. The program of claim 49 wherein the first issue summary may be accessed for further processing, the program updating information in the database to provide a record of who accessed the first issue summary, a description a reason for the access, and a record of when the access occurred.

52. The program of claim 50 further including an issue duplication feature which permits the operator to create a second issue summary that duplicates certain information included in the first issue summary.

53. The program of claim 52 wherein the issue duplication feature activates the second routine and creates a second issue summary including the same consumer information and issue information as the first issue summary.

54. The program of claim 52 wherein the issue duplication feature activates the third routine and creates a second issue summary including the same consumer information and product information as the first issue summary.

55. The program of claim 52 wherein the issue duplication feature activates the first routine and creates a second issue summary including the same product information and issue information as the first issue summary.

56. A program for processing contacts from consumers, including:
an identification routine for generating an identification screen to enable an operator to input information identifying a consumer contacting the operator to communicate an issue;
a look-up routine for searching a database containing a plurality of issue histories to identify an issue history associated with the consumer; and
a subject routine for generating a subject screen to enable the operator to input information relating to the issue, the subject routine further generating an issue summary containing the issue information for storage in the database as part of the issue history associated with the consumer.

57. The program of claim 56 wherein the contacts from consumers are telephone calls.

58. The program of claim 56 wherein the contacts from consumers are email messages.

59. The program of claim 56 further including an activity routine for generating an activity screen to enable the operator to input information describing an activity to address the issue.

60. The program of claim 59 further including an issue screen corresponding to the operator, the issue screen including issues associated with the operator that remain the responsibility of the operator.

61. The program of claim 60 wherein the operator may assign responsibility for an issue to any of a plurality of other parties, the program further including issue screens corresponding to each of the plurality of other parties, the operator issue screen and the other party issue screens being accessible over a network.

62. The program of claim 59 wherein the operator may assign responsibility for the issue to a plurality of other parties by forwarding the issue to a queue corresponding to the plurality of other parties.

63. The program of claim 62 wherein any of the plurality of other parties can access the queue using a web browser.

64. The program of claim 56 further including a letter routine for generating a letter screen to enable the operator to create a letter to the consumer regarding the issue.

65. The program of claim 64 further including an enclosure routine for generating an enclosure screen to enable the operator to define an enclosure to be included with the letter.

66. The program of claim 56 further including a survey routine for generating a survey screen to enable the operator to input information describing responses of the consumer to survey questions.

67. The program of claim 64 wherein the letter includes default content based on the information relating to the issue.

68. The program of claim 67 wherein the operator can modify the default content.

69. The program of claim 67 wherein the operator can modify distribution settings associated with the letter.

70. The program of claim 64 wherein the letter is generated in digital form as part of a print file.

71. The program of claim 56 wherein the look-up routine displays a summary of the consumer issue history to the operator.

72. The program of claim 56 further including a report routine for generating a report including information from the plurality of issue histories.

73. The program of claim 72 wherein the report is described by a report profile, the user being able to save the report profile and schedule periodic report generation events.

74. The program of claim 72 further including a report server configured to receive report requests over a network from users of the report routine, and to transmit reports to the users via one of e-mail and an ftp site.

75. The program of claim 72 wherein the report server is configured to post reports to a secured web site accessible by the users.

76. A method for processing calls from consumers, including the steps of:
receiving a call from a consumer calling to communicate an issue;
obtaining information identifying the consumer;
using the consumer identifying information to retrieve a consumer history associated with the consumer, the consumer history including previously generated issue summaries relating to the consumer;
obtaining information relating to the issue;
generating an issue summary based on the issue information;
adding the issue summary to the consumer history; and
storing the consumer history.

77. The method of claim 76 further including the step of generating an activity file including information describing an activity to address the issue.

78. The method of claim 77 further including the step of generating an issue screen corresponding to the operator, the issue screen including issue summaries associated with the operator that remain the responsibility of the operator.

79. The method of claim 77 further including the step of assigning responsibility for the issue by forwarding the issue summary to another party, thereby adding the issue summary to an issue screen associated with the other party.

80. The method of claim 76 further including the step of generating a letter to the consumer based on the issue information.

81. The method of claim 80 wherein the letter generating step includes the step of selecting an enclosure to accompany the letter.

82. A method for organizing a database containing information describing calls from consumers, including the steps of:
receiving a first call from a consumer;
storing a consumer identifier in the database;
linking in the database information describing the first call with the consumer identifier;
receiving a second call from the consumer; and
linking in the database information describing the second call from the consumer with the consumer identifier.

83. The method of claim 82 further including the step of generating a first activity file including information describing a first activity to address an issue associated with the first call.

84. The method of claim 83 further including the step of linking in the database the first activity file with the consumer identifier.

85. The method of claim 84 further including the step of generating a second activity file including information describing a second activity to address an issue associated with the second call.

86. The method of claim 85 further including the step of linking in the database the second activity file with the consumer identifier.
